(19) United States
(12) Patent Application Publication
(10) Pub. No.: US 2024/0348405 A1
(43) Pub. Date: Oct. 17, 2024

(54) SYSTEM AND METHOD FOR MONITORING PDCCH IN OVERLAPPING MONITORING OCCASSIONS BASED ON CORESET PRIORITIZATION

(71) Applicant: Samsung Electronics Co., Ltd., Gyeonggi-do (KR)

(72) Inventors: Hamid SABER, San Diego, CA (US); Jung Hyun BAE, San Diego, CA (US)

(21) Appl. No.: 18/630,369

(22) Filed: Apr. 9, 2024

Related U.S. Application Data
(60) Provisional application No. 63/459,021, filed on Apr. 13, 2023.

(51) Int. Cl. H04L 5/00

(52) U.S. Cl. CPC H04L 5/0053

(57) ABSTRACT

A system and a method are disclosed for monitoring a PDCCH. A method performed by a UE includes i. selecting a CORESET from among a set of CORESETs in a slot; ii. determining a qcl type value of the reference CORESET; iii. determining a first set of CORESETs in the set of CORESETs in the slot that overlap with the reference CORESET and have a same qcl type value as the reference CORESET; iv. determining a second set of CORESETs in the set of CORESETs in the slot that overlaps with the first set of CORESETs and has a different qcl type value than the reference CORESET; and v. removing, from the set of CORESETs in the slot, the first and second sets of CORESETs.

### CROSS-REFERENCE TO RELATED APPLICATION

This application claims the priority benefit under 35 U.S.C. § 119 (e) of U.S. Provisional Application No. 63/459,021, filed on Apr. 13, 2023, the disclosure of which is incorporated by reference in its entirety as if fully set forth herein.

### TECHNICAL FIELD

The disclosure generally relates to monitoring a physical downlink control channel (PDCCH). More particularly, the subject matter disclosed herein relates to improvements to monitoring PDCCH candidates in overlapping PDCCH monitoring occasions (MOs) in multiple control resource sets (CORESETs).

### SUMMARY

In systems that are compatible with new radio (NR) technology, a control channel of a user equipment (UE) may be monitored in a particular time/frequency resource referred to as a CORESET, which is only a part of a system band. In such scenarios, a time point/occasion for monitoring the control channel may be given. However, depending on situations, the MOs of the control channel may overlap among a plurality of CORESETs. In this case, problems may arise in relation to how a UE should monitor the control channel.

In 3^{rd} generation partnership project (3GPP) Rel-15, a UE monitors PDCCH candidates for detection of downlink control information (DCI) in a search space (SS) on a scheduling cell. More specifically, in TS 38.213 v.15 of the 3GPP specification, different types of SSs are described as shown in Table 1 below.

TABLE 1
TS 38.213 clause 10

a Type0-PDCCH CSS set configured by pdcch-ConfigSIB1 in MIB or by
searchSpaceSIB1 in PDCCH-ConfigCommon or by searchSpaceZero in PDCCH-
ConfigCommon for a DCI format with CRC scrambled by a SI-RNTI on the primary cell of the
MCG
a Type0A-PDCCH CSS set configured by searchSpaceOtherSystemInformation in
PDCCH-ConfigCommon for a DCI format with CRC scrambled by a SI-RNTI on the primary
cell of the MCG
a Type1-PDCCH CSS set configured by ra-SearchSpace in PDCCH-ConfigCommon
for a DCI format with CRC scrambled by a RA-RNTI, a MsgB-RNTI, or a TC-RNTI on the
primary cell
a Type2-PDCCH CSS set configured by pagingSearchSpace in PDCCH-
ConfigCommon for a DCI format with CRC scrambled by a P-RNTI on the primary cell of the
MCG
a Type3-PDCCH CSS set configured by SearchSpace in PDCCH-Config with
searchSpaceType = common for DCI formats with CRC scrambled by INT-RNTI, SFI-RNTI,
TPC-PUSCH-RNTI, TPC-PUCCH-RNTI, TPC-SRS-RNTI, CI-RNTI, or PS-RNTI and, only
for the primary cell, C-RNTI, MCS-C-RNTI, or CS-RNTI(s), and
a USS set configured by SearchSpace in PDCCH-Config with searchSpaceType = ue-
Specific for DCI formats with CRC scrambled by C-RNTI, MCS-C-RNTI, SP-CSI-RNTI, CS-
RNTI(s), SL-RNTI, SL-CS-RNTI, or SL-L-CS-RNTI.

As shown in Table 1 above, an SS is categorized into a common SS (CSS) and a UE-specific (USS).

Based on the foregoing, a UE monitors PDCCH candidates during MOs defined via SS configurations. An SS is associated with a CORESET that determines the frequency resources for PDCCH monitoring as well as a length of PDCCH candidates in terms of a number of orthogonal frequency division multiplexing (OFDM) symbols. The number of PDCCH candidates for each SS may be configured via radio resource control (RRC).

For example, an SS can be configured with 10 PDCCH candidates, associated with a CORESET length of 3 and an MO in the first three symbols in each slot. In this case, a UE monitors the 10 PDCCH candidates in different frequency resources, but in each of the first 3 symbols of the slots.

Details of the conventional SS configurations and PDCCH monitoring behaviors are given in TS 38.331 v.15 and TS 38.213 v.15.

Among these details, a specific behavior for PDCCH monitoring pertains overlapping CORESETs with different quasi co location (QCL) type, i.e., qcl-D, values, which provide information about a receiver analog beam. Typically, a UE is not capable of receiving two overlapping channels with different values of qcl-D, i.e., over different beams. However, since restricting a base station, e.g., a gNB, to always configure the SS with non-overlapping qcl-Ds is not desired, legacy NR, in Rel-15, provides a procedure for a UE to determine a CORESET to monitor in case multiple CORESETs with different qcl-D values overlapping in a time domain.

Table 2 below is an excerpt from TS 38.213 v.15, which defines the UE behavior.

TABLE 2
TS 38.213 clause 10.1

“If a UE
is configured for single cell operation or for operation with carrier aggregation in a same
frequency band, and
monitors PDCCH candidates in overlapping PDCCH monitoring occasions in multiple
CORESETs that have been configured with same or different qcl-Type set to ′typeD′
properties on active DL BWP(s) of one or more cells
the UE monitors PDCCHs only in a CORESET, and in any other CORESET from the multiple
CORESETs that have been configured with qcl-Type set to same ′typeD′ properties as the
CORESET, on the active DL BWP of a cell from the one or more cells
the CORESET corresponds to the CSS set with the lowest index in the cell with the
lowest index containing CSS, if any; otherwise, to the USS set with the lowest index in
the cell with lowest index
the lowest USS set index is determined over all USS sets with at least one PDCCH
candidate in overlapping PDCCH monitoring occasions”

To simply summarize Table 2, among overlapping CORESETs, a UE selects one reference CORESET, which is associated with a qcl-D value. Thereafter, the UE monitors PDCCHs in the reference CORESET and in every other CORESET in the group of overlapping CORESETs that have the same qcl-D value.

As indicated in Table 2 above, the reference CORESET may corresponds to a CSS set with a lowest index in a cell with a lowest index containing CSS, if any; and otherwise, to a USS set with a lowest index in the cell with the lowest index.

For example, FIG. 1 illustrates an example of overlapping CORESETs.

Referring to FIG. 1, based on the behavior defined in Table 2 above, a UE only monitors USS #0 and #2. That is, the UE selects USS #0 as a reference CORESET, and then monitors PDCCHs in the reference CORESET and in USS #2, i.e., the other CORESET in the group of overlapping CORESETs that has the same qcl-D value (e.g., qcl-D value A).

However, the aforementioned behavior in Table 2 can be interpreted differently in specific SS configuration scenarios, which may result in a misunderstanding between a UE and a gNB in relation to the monitored CORESET. For example, specification does not clearly define a set of overlapping MOs/CORESETs.

Further, for intra-band carrier aggregation (CA) with different subcarrier spacing (SCS), the specification only considers cells with the same numerology. That is, in case of different SCS numerologies between cells in intra-band CA, which slot is to be processed first is unclear. To overcome these issues, systems and methods are described herein, which clearly define novel standardized UE behavior to address the issues mentioned above. Specifically, the approaches described herein improve on previous methods by defining new modes of UE operations configured to prevent miscommunications and misinformation between a UE and a gNB as it relates to a monitored CORESET.

In an embodiment, a method performed by a UE in a wireless communication system includes i. selecting a CORESET from among a set of CORESETs in a slot; ii. determining a qcl type value of the reference CORESET; iii. determining a first set of CORESETs in the set of CORESETs in the slot that overlap with the reference CORESET and have a same qcl type value as the reference CORESET; iv. determining a second set of CORESETs in the set of CORESETs in the slot that overlaps with the first set of CORESETs and has a different qcl type value than the reference CORESET; and v. removing, from the set of CORESETs in the slot, the first and second sets of CORESETs.

In an embodiment, a UE includes a transceiver; a processor; and a memory operably connectable to the processor and storing instructions that, when executed by the processor, perform operations including i. selecting a CORESET from among a set of CORESETs in a slot; ii. determining a qcl type value of the reference CORESET; iii. determining a first set of CORESETs in the set of CORESETs in the slot that overlap with the reference CORESET and have a same qcl type value as the reference CORESET; iv. determining a second set of CORESETs in the set of CORESETs in the slot that overlaps with the first set of CORESETs and has a different qcl type value than the reference CORESET; and v. removing, from the set of CORESETs in the slot, the first and second sets of CORESETs.

### BRIEF DESCRIPTION OF THE DRAWING

In the following section, the aspects of the subject matter disclosed herein will be described with reference to exemplary embodiments illustrated in the figures, in which:

FIG. 1 illustrates an example of overlapping CORESETs;

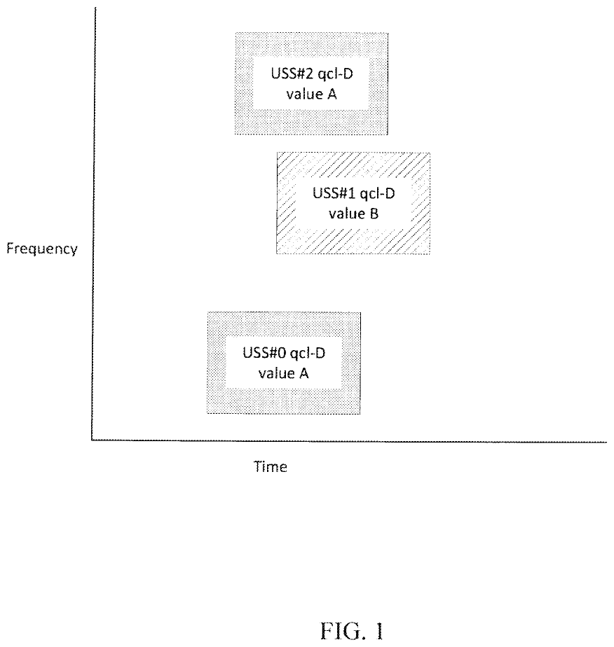

FIG. 2 illustrates an example of multiple CORESETs;

FIG. 3 illustrates another example of multiple CORESET;

FIG. 4 illustrates an example of ambiguity in CORESET prioritization for CA with different numerologies;

FIG. 5 illustrates an example selecting multiple reference CORESETs according to an embodiment;

FIG. 6A is flowchart illustrating a method performed by a UE according to an embodiment;

FIG. 6B is flowchart illustrating a method performed by a UE according to an embodiment;

FIG. 7A is flowchart illustrating a method performed by a UE according to an embodiment;

FIG. 7B is flowchart illustrating a method performed by a UE according to an embodiment;

FIG. 8 is a block diagram illustrating an electronic device in a network environment, according to an embodiment; and

FIG. 9 illustrates a system including a UE and a gNB in communication with each other, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As described above, an aspect of the disclosure is to provide methods that clearly define UE behavior in monitoring PDCCH candidates in overlapping PDCCH MOs in multiple CORESETs.

Herein, the rule for selecting a CORESET according to Table 2 above will be referred to as the “reference rule”. A described above, the reference rule may be used to determine a CORSET among a set of overlapping CORESET in the same cell or across different cells.

However, the reference rule can be interpreted differently in specific SS configuration scenarios, which may result in misunderstanding between a UE and a gNB regarding the monitored CORESET.

More specifically, how to define a set of overlapping MOs/CORESETs is not clearly specified in the reference rule.

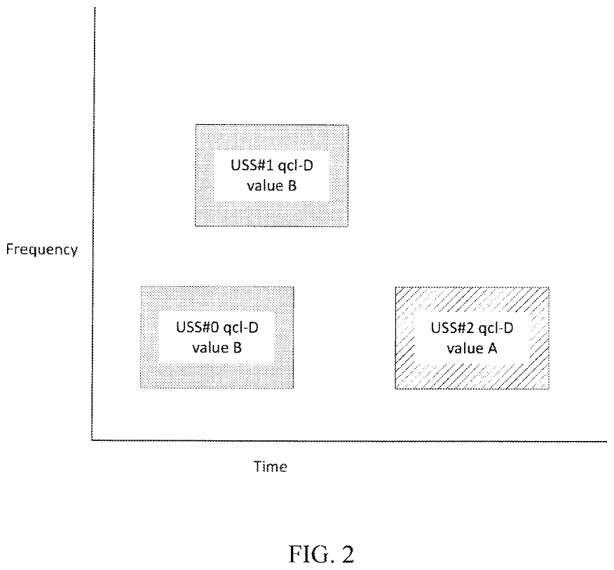

FIG. 2 illustrates an example of multiple CORESETs.

Referring to FIG. 2, if each of CORESETs USS #0, USS #1, and USS #2 is considered in one set, based on the reference rule, USS #2 is unnecessarily not monitored. That is, according to the current procedure to resolve a collision among overlapping CORESETs, all three CORESETs are considered as one set and the reference CORESET is selected as USS #0. Consequently, only CORESETs with QCL-D value of B will be monitored by UE. Therefore, USS #2 will be killed.

However, if CORESETs USS #0 and USS #1 are considered as one set, and USS #2 is considered as another set, then, based on the reference rule, all of CORESETs USS #0, USS #1, and USS #2 will be monitored.

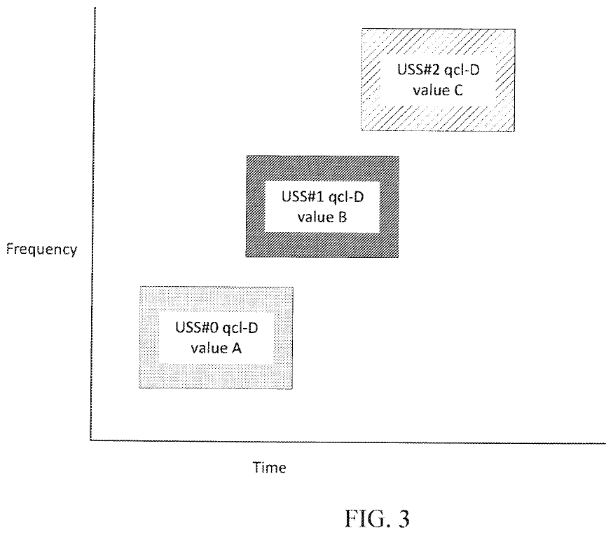

FIG. 3 illustrates another example of multiple CORESETs.

Referring to FIG. 3, based on the reference rule, USS #2 is unnecessarily dropped if each of CORESETs USS #0, USS #1, and USS #2 is considered to be in one set.

However, if USS #0 and USS #1 are processed first, then there will be two overlapping sets and more CORESETs will be monitored. Similar behavior exists for handing a semi-persistent scheduling (SPS) collision.

As another issue with the reference rule, for intra-band CA with different SCS, only cells with the same numerology are considered. Consequently, when there are different SCS numerologies between the cells in the intra-band CA, which slot is processed first is unclear.

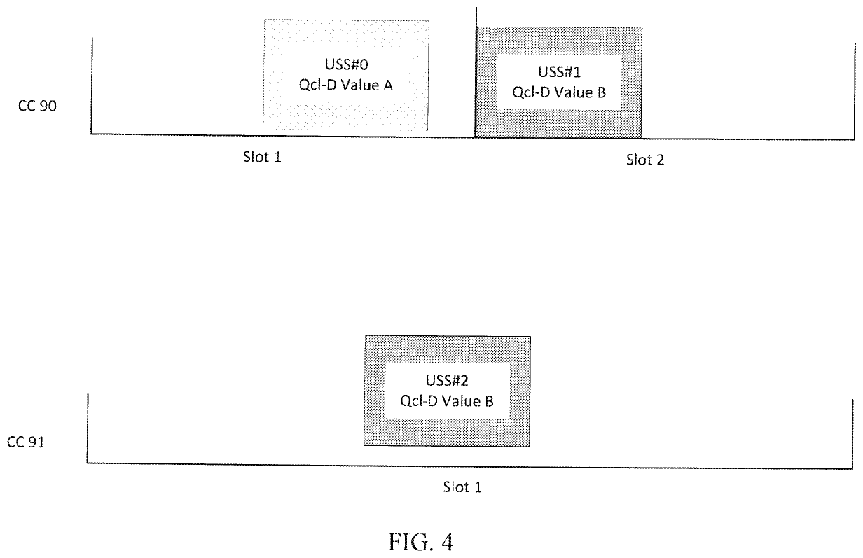

FIG. 4 illustrates an example of ambiguity in CORESET prioritization for CA with different numerologies.

Referring to FIG. 4, if a UE first processes a first slot of component carrier (CC) #0, then USS #2 is dropped. However, if the UE first processes a second slot of CC #0, then USS #2 is not dropped, but how to handle USS #0 is then not clear.

Accordingly, the various embodiments described below are provided to address these type of issues in the conventional art.

### Single Cell

In accordance with an embodiment of the disclosure, a set of overlapping CORESETs is defined based on an order in time they appear in a slot. For example, this procedure is similar to pseudo-code for physical downlink shared channel (PDSCH) SPS collision handling in Rel-16.

### Method 1: Based on SPS Collision Handling

In accordance with an embodiment, a UE applies a CORESET prioritization rule, slot by slot.

More specifically, in a given slot, a UE determines a reference CORESET according to the reference rule. The UE then monitors each CORESET that overlaps with the reference CORESET and has the same value of qcl-D as the reference CORESET. Each CORESET that overlaps with the reference CORESET and has different qcl-D value is removed.

After removing the processed CORESET according to the above, the UE then process the remaining set of CORESETs in the slot. This process continues until no more CORESETs remain in the slot.

Table 3 below provides an algorithm for Method 1.

TABLE 3
Step 0: Set Q as the set of all CORESETs in the slot. Let S be a set of surviving
CORESETs, i.e., CORESETs that are not dropped and then monitored by the UE. Initialize S
as an empty set.
Step 1: The UE selects a reference CORESET from the set Q according to the reference
rule. Assuming the qcl-D value of this CORESET is A, the UE monitors all of the CORESETs
that overlap with the reference CORESET and have a qcl-D value of A.
Step 2: The surviving CORESETs in Step 1 and every other CORESET in set Q that
overlaps with the reference CORESET but has a value of qcl-D that is different than A, are then
removed from the set Q.
Step 3: Repeat step 1 and 2 until Q is empty.

Referring again to FIG. 3, using the steps above in Table 3, USS #0 and USS #2 survive, i.e., are monitored by the UE. That is, unlike using reference rule as described above with reference to FIG. 3, wherein USS #2 is unnecessarily dropped if each of CORESETs USS #0, USS #1, and USS #2 is considered to be in one set, by using the steps above in Table 3 USS #2 is not dropped.

Using Method 1, a reference CORESET can be any CORESET in the slot, which makes it possible that a later CORESET may prevent monitoring of an earlier CORESET due to the differing values of qcl-D.

Therefore, in accordance with an embodiment, an alternative scheme is provided in which CORESETs are prioritized based on their qcl-D values considering their start time. More specifically, Method 1 can be reused with a modification that a reference CORESET is selected according to any of the following:
1. A reference CORESET is a CORESET with an earliest starting symbol in a slot. If there are multiple CORESETS (MOs/SSs) with the earliest starting symbol in the slot, the CORESET with the longest or smallest duration may be chosen as the reference CORESET.
2. A reference CORESET is a CORESET corresponding to a CSS with an earliest starting time. If there are multiple such CORESETs, one may be chosen based on a smallest or longest duration of the CORESET. If there is no CSS in the slot, the same method may be applied considering all USSs in the slot.

### Carrier Aggregation (CA)

The reference rule may also apply to overlapping across serving cells or CCs. Therefore, CA behavior should also be clearly defined without ambiguity. The prioritization can be applied for intra-band CA or inter-band CA, although it is generally more relevant to intra-band CA.

### Same Numerology Across CCs

In case of the same numerology, UE behavior can be defined according to a single cell as slot durations are all the same. Therefore, a reference CORESET determination may still be performed according to the legacy reference rule, but unlike the single cell, it also takes into account a cell index for reference CORESET selection.

### Different Numerology Across CCs

With different numerologies and slot durations across CCs, which slot a UE processes first may result in a different set of monitored CORESETs. For example, referring again to FIG. 4, if the UE first processes a first slot of CC #0 and determines the CORESET/USS #0 as the reference CORESET, the UE will then monitor CORESET/USS #1 and does not monitor USS #2. On the other hand, if the first UE processes the second slot, the UE determines the reference CORESET to be USS #1, monitors USS #2, and does not monitor USS #0.

In one scheme, a UE processes slots in an ascending order of time on a cell with a smallest cell identifier (ID). However, if an SCS of this cell is larger than another cell, there will be effect propagation to the next slots. Therefore, a time unit may be defined based on a smallest SCS among the cells. An example of effect propagation to the next slot can be seen in FIG. 4, if a modification is made to USS #2. For example, if the QCL-D value of USS #2 is changed to A, then collision handling in slot 1 of CC 90 results in monitoring both USS #0 and USS #2. However, monitoring USS #2 requires USS #1 to be killed in the next slot due to different QCL-D values, hence effect propagation to the next slot.

### Method 2: Smallest SCS Time Unit

In accordance with an embodiment, to remove any effects of different SCSs, a time unit may be defined as a slot of a cell with a smallest SCS, i.e., a longest slot duration. All overlapping slots with this slots are considered for CORESET prioritization handling and a single cell method may be applied after determining a reference CORESET according to the legacy reference rule considering cell indices, SS type, etc.

Due to different numerologies, multiple reference CORESETs may be selected, e.g., in one step of Method 1, in a time unit. For example, this may be handled by assuming the reference CORESET includes all the symbols of the individual reference CORESET.

Alternatively, a reference CORESET can be assumed to start from a first symbol of a reference CORESET with an earliest start symbol and end at an ending symbol of a reference CORESET with a latest ending symbol.

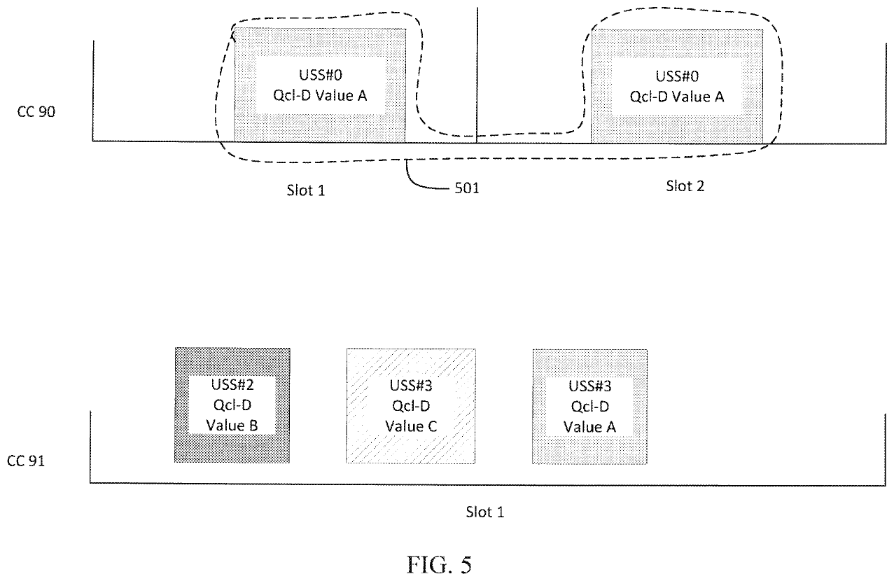

FIG. 5 illustrates an example selecting multiple reference CORESETs according to an embodiment.

Referring to FIG. 5, there are originally two reference CORESETs in a time unit (i.e., a longest slot). Since the reference CORESETs have the same value of qcl-D, one equivalent reference CORESET may be determined as shown by the dashed line 501, and algorithm method of Table 3 may be applied assuming the new equivalent reference CORESET. For example, if Method 1 is applied, the UE ends up monitoring USS #0 in two slots of CC #0 and USS #3.

### Method 3: Largest SCS Time Unit

In accordance with an embodiment, according to Method 3, a time unit may be selected as a slot duration of a cell with a largest SCS numerology. Method 3 may be preferential in some instances as it requires fewer look-ahead operations at a UE side.

Once such a time unit is selected, a UE processes slots in an ascending order of a slot start time or a slot number.

Any of the above-described methods applied for CA with the same numerology can be reused considering all the CORESETs/MOs appearing within the considered time unit. A CORESET is considered to be in the time unit if its starting symbol starts in the time unit.

Once a set of surviving CORESETs is determined for a given slot n, the process moves to a next slot n+1. Each surviving CORESET from processing slot n, which ends at slot n+1, is monitored and participates in CORESET prioritization in slot n+1.

Any CORESET that starts in slot n+1 and overlaps with a surviving CORESET with a different value of qcl-D is dropped and then slot n+1 is processed like slot n above. This process continues for each slot in an ascending order of the slot numbers.

### UE Capability Aspects

With any of the aforementioned methods within a time unit, a UE runs a certain procedure to determine the monitored CORESETs. The process of determining the CORESETs involves processing a footprint of MOs and CORESETs in the same cell or across different cells and is closely proportional to a number of overlapping chunks identified during the process. Therefore, a UE capability may be considered to address a processing complexity of such operations. The notion of chunk is defined in steps 1 and 2 of Method 1 above, e.g., in Table 3, as “the surviving CORESETs” obtained after step 1 is a chunk of overlapping CORESETs.

A chunk can also be defined in the following way. A set of CORESETs may be defined as a chunk if one CORESET, referred to as a reference CORESET, can be identified in the set, such that every other CORESET overlaps with the reference CORESET in time domain.

In accordance with an embodiment, a UE is not expected to process more than M overlapping chunks (number of times running Step 1 and/or Step 2 in Method 1), in the process of determining the monitored CORESETs. The number M may be reported separately for a single cell operation and a CA operation. With a CA operation, the UE may report a maximum number of chunks that it expects to be created/processed across all of the cells.

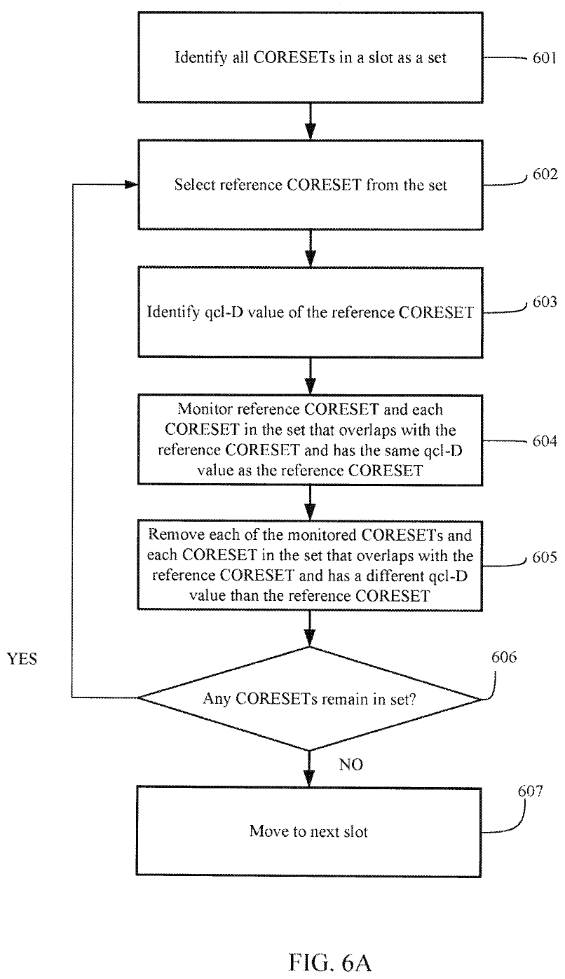

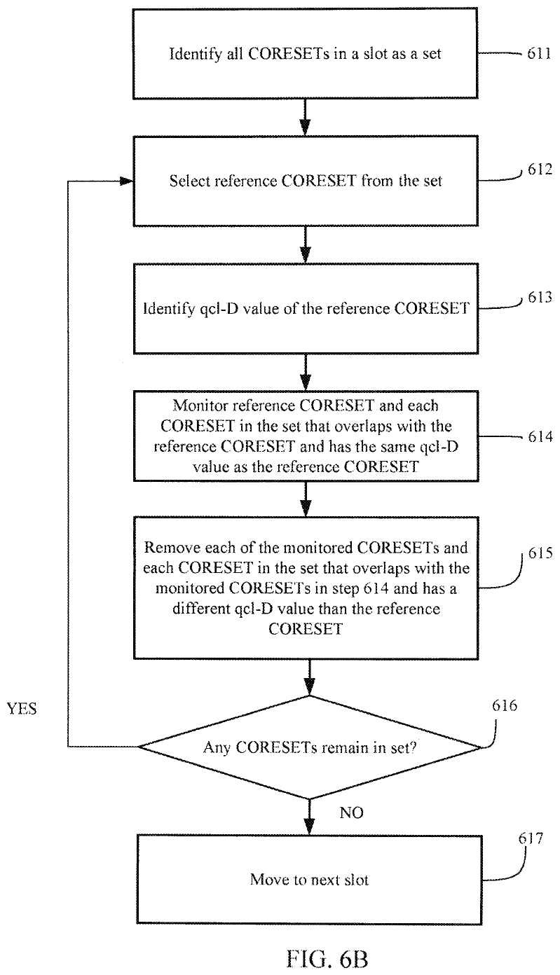

FIG. 6A is flowchart illustrating a method performed by a UE according to an embodiment. More specifically, FIG. 6A illustrates a method performed by a UE in overlapping PDCCH MOs in multiple CORESETs in a single cell or among CCs with same numerologies.

Referring to FIG. 6A, in step 601, the UE identifies all CORESETs in a slot as a set.

In step 602, the UE selects a reference CORESET from the set. For example, as described above, the reference CORESET may be a CORESET having a lowest index among the CORESETs in the set.

In step 603, the UE identifies a qcl-D value of the reference CORESET.

In step 604, the UE monitors the PDCCH in the reference CORESET and each CORESET in the set that overlaps with the reference CORESET and has the same qcl-D value as the reference CORESET.

In step 605, the UE removes, from the set, each of the monitored CORESETs and each CORESET in the set that overlaps with the reference CORESET and has a different qcl-D value than the reference CORESET.

As describes above in Table 3, the process continues until no CORESETs remain in the set.

Accordingly, in step 606, the UE determines if any CORESETs remain in the set. If yes, the method returns to step 602 and another reference CORESET is selected. If no, the UE moves to a next slot in step 607.

FIG. 6B is flowchart illustrating a method performed by a UE according to an embodiment. More specifically, FIG. 6B illustrates a method performed by a UE in overlapping PDCCH MOs in multiple CORESETs in a single cell or among CCs with same numerologies.

Referring to FIG. 6B, in step 611, the UE identifies all CORESETs in a slot as a set.

In step 612, the UE selects a reference CORESET from the set. For example, as described above, the reference CORESET may be a CORESET having a lowest index among the CORESETs in the set.

In step 613, the UE identifies a qcl-D value of the reference CORESET.

In step 614, the UE monitors the PDCCH in the reference CORESET and each CORESET in the set that overlaps with the reference CORESET and has the same qcl-D value as the reference CORESET.

In step 615, the UE removes, from the set, each of the monitored CORESETs and each CORESET in the set that overlaps with the monitored CORESETs in step 614 and has a different qcl-D value than the reference CORESET.

In step 616, the UE determines if any CORESETs remain in the set. If yes, the method returns to step 612 and another reference CORESET is selected. If no, the UE moves to a next slot in step 617. Accordingly, the process continues until no CORESETs remain in the set.

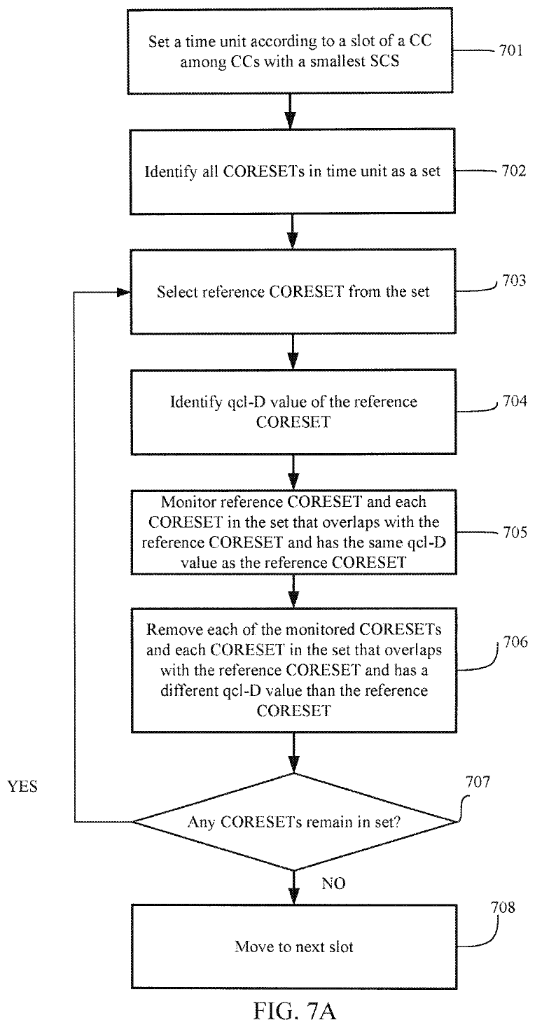

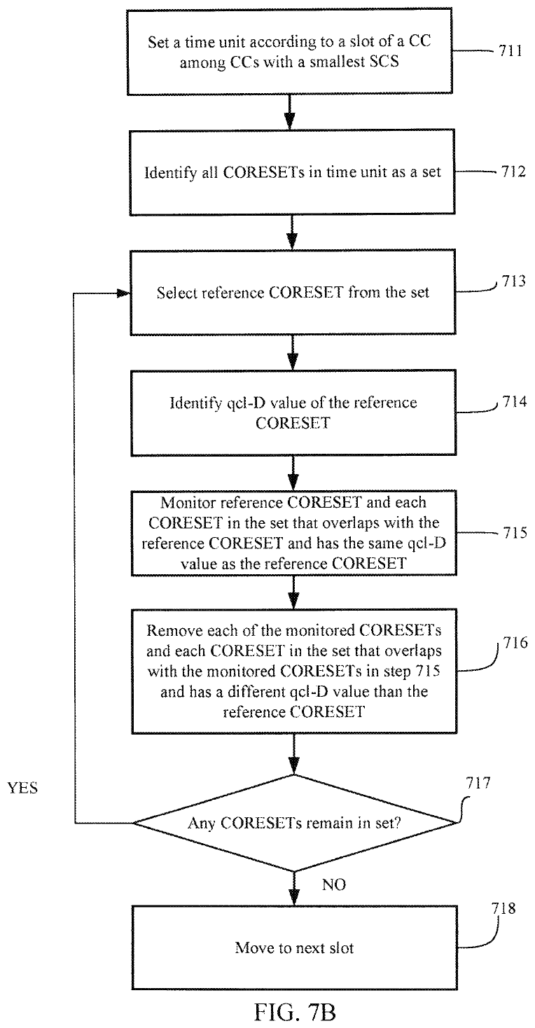

FIG. 7A is flowchart illustrating a method performed by a UE according to an embodiment. More specifically, FIG. 7A illustrates a method performed by a UE in overlapping PDCCH MOs in multiple CORESETs among CCs with different numerologies.

Referring to FIG. 7A, in step 701, the UE sets a time unit according to a slot of a CC among the CCs with a smallest SCS.

In step 702, the UE identifies all CORESETs in the time unit as a set.

In step 703, the UE selects a reference CORESET from the set. For example, as described above, the reference CORESET may be a CORESET having a lowest index among the CORESETs in the set.

In step 704, the UE identifies a qcl-D value of the reference CORESET.

In step 705, the UE monitors the PDCCH in the reference CORESET and each CORESET in the set that overlaps with the reference CORESET and has the same qcl-D value as the reference CORESET.

In step 706, the UE removes, from the set, each of the monitored CORESETs and each CORESET in the set that overlaps with the reference CORESET and has a different qcl-D value than the reference CORESET.

In step 707, the UE determines if any CORESETs remain in the set. If yes, the method returns to step 703 and another reference CORESET is selected. If no, the UE moves to a next slot in step 708. Accordingly, the process continues until no CORESETs remain in the set.

FIG. 7B is flowchart illustrating a method performed by a UE according to an embodiment. More specifically, FIG. 7B illustrates a method performed by a UE in overlapping PDCCH MOs in multiple CORESETs among CCs with different numerologies.

Referring to FIG. 7B, in step 711, the UE sets a time unit according to a slot of a CC among the CCs with a smallest SCS.

In step 712, the UE identifies all CORESETs in the time unit as a set.

In step 713, the UE selects a reference CORESET from the set. For example, as described above, the reference CORESET may be a CORESET having a lowest index among the CORESETs in the set.

In step 714, the UE identifies a qcl-D value of the reference CORESET.

In step 715, the UE monitors the PDCCH in the reference CORESET and each CORESET in the set that overlaps with the reference CORESET and has the same qcl-D value as the reference CORESET.

In step 716, the UE removes, from the set,
each of the monitored CORESETs and each CORESET in the set that overlaps with the monitored CORESETs in step 715 and has a different qcl-D value than the reference CORESET.

In step 717, the UE determines if any CORESETs remain in the set. If yes, the method returns to step 713 and another reference CORESET is selected. If no, the UE moves to a next slot in step 718. Accordingly, the process continues until no CORESETs remain in the set.

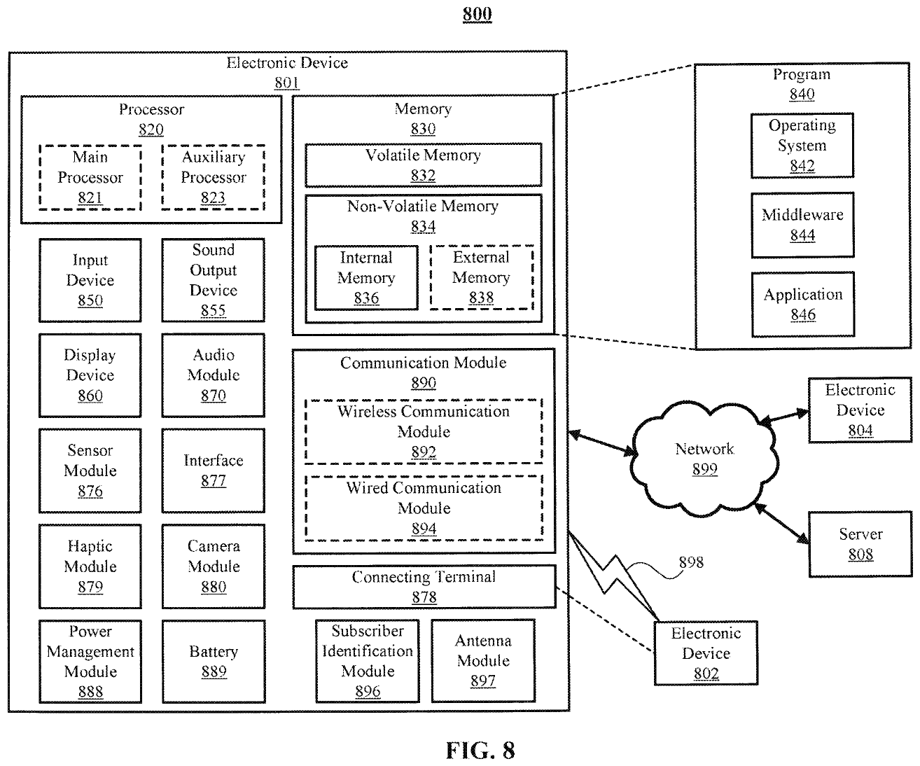

FIG. 8 is a block diagram of an electronic device in a network environment 800, according to an embodiment.

Referring to FIG. 8, an electronic device 801 in a network environment 800 may communicate with an electronic device 802 via a first network 898 (e.g., a short-range wireless communication network), or an electronic device 804 or a server 808 via a second network 899 (e.g., a long-range wireless communication network). For example, the electronic device may by a UE that performs the methods illustrated in FIGS. 6A, 6B, 7A, and 7B.

The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device (e.g., a display).

The processor 820 may execute software (e.g., a program 840) to control at least one other component (e.g., a hardware or a software component) of the electronic device 801 coupled with the processor 820 and may perform various data processing or computations.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU) or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838.

The program 840 may be stored in the memory 830 as software, and may include, for example, an operating system (OS) 842, middleware 844, or an application 846.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 899, may be selected, for example, by the communication module 890 (e.g., the wireless communication module 892). The signal or the power may then be transmitted or received between the communication module 890 and the external electronic device via the selected at least one antenna.

Commands or data may be transmitted or received between the electronic device 801 and the external electronic device 804 via the server 808 coupled with the second network 899. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

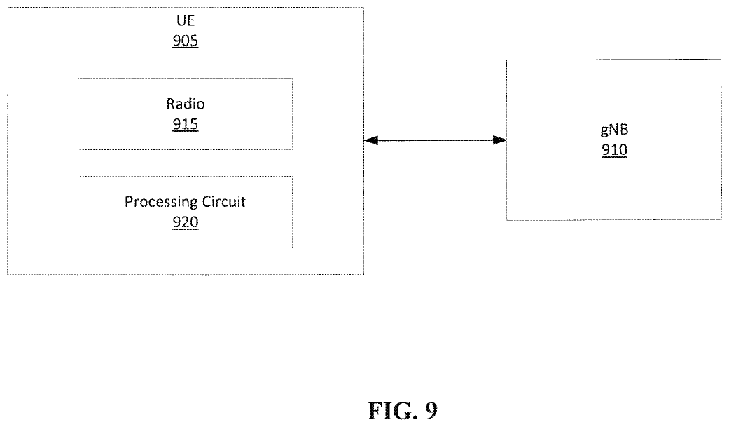

FIG. 9 shows a system including a UE 905 and a gNB 910, in communication with each other. The UE may include a radio 915 and a processing circuit (or a means for processing) 920, which may perform various methods disclosed herein, e.g., the method illustrated in FIG. 6A, 6B, 7A, or 7B. For example, the processing circuit 920 may receive, via the radio 915, transmissions from the network node (gNB) 910, and the processing circuit 920 may transmit, via the radio 915, signals to the gNB 910.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method performed by a user equipment (UE) in a wireless communication system, the method comprising:
i. selecting a reference control resource set (CORESET) from among a set of CORESETs in a slot;
ii. determining a quasi co location (qcl) type value of the reference CORESET;
iii. determining a first set of CORESETs in the set of CORESETs in the slot that overlap with the reference CORESET and have a same qcl type value as the reference CORESET;
iv. determining a second set of CORESETs in the set of CORESETs in the slot that overlaps with the first set of CORESETs and has a different qcl type value than the reference CORESET; and
v. removing, from the set of CORESETs in the slot, the first and second sets of CORESETs.

2. The method of claim 1, further comprising repeating i. through v. until no CORESETs remain in the set.

3. The method of claim 1, wherein the reference CORESET includes a CORESET having a lowest index among the CORESETs in the set.

4. The method of claim 1, wherein the reference CORESET includes a CORESET with an earliest starting symbol in the slot.

5. The method of claim 1, wherein the reference CORESET includes a CORESET with a longest or a smallest duration selected among multiple CORESETS with a same earliest starting symbol in the slot.

6. The method of claim 1, wherein the reference CORESET includes a CORESET corresponding to a common search space (CSS) with an earliest starting time.

7. The method of claim 1, wherein the reference CORESET includes a CORESET with a smallest or longest duration of selected from multiple such CORESETs corresponding to a common search space (CSS) with a same earliest starting time.

8. The method of claim 1, wherein the reference CORESET corresponds to:
a common search space (CSS) with a lowest index in a cell with a lowest cell index containing CSS, if any; and
otherwise, corresponds to a UE search space (USS) with a lowest index in the cell with the lowest cell index.

9. The method of claim 1, further comprising, in overlapping physical downlink control channel (PDCCH) monitoring occasions in multiple CORESETs in a single cell or among component carriers with same numerologies, identifying the CORESETs in the slot as the set.

10. The method of claim 1, further comprising:
in overlapping physical downlink control channel (PDCCH) monitoring occasions in multiple CORESETs among component carriers (CCs) with different numerologies, setting a time unit according to a slot of a CC among the CCs with a smallest subcarrier spacing (SCS); and
identifying CORESETs in the time unit as the set.

11. A user equipment (UE), comprising:
a transceiver;
a processor; and
a memory operably connectable to the processor and storing instructions that, when executed by the processor, perform operations comprising:
i. selecting a reference control resource set (CORESET) from among a set of CORESETs in a slot;
ii. determining a quasi co location (qcl) type value of the reference CORESET;
iii. determining a first set of CORESETs in the set of CORESETs in the slot that overlap with the reference CORESET and have a same qcl type value as the reference CORESET;
iv. determining a second set of CORESETs in the set of CORESETs in the slot that overlaps with the first set of CORESETs and has a different qcl type value than the reference CORESET; and
v. removing, from the set of CORESETs in the slot, the first and second sets of CORESETs.

12. The UE of claim 11, wherein the instructions, when executed by the processor, perform operations further comprising repeating i. through v. until no CORESETs remain in the set.

13. The UE of claim 11, wherein the reference CORESET includes a CORESET having a lowest index among the CORESETs in the set.

14. The UE of claim 11, wherein the reference CORESET includes a CORESET with an earliest starting symbol in the slot.

15. The UE of claim 11, wherein the reference CORESET includes a CORESET with a longest or a smallest duration selected among multiple CORESETS with a same earliest starting symbol in the slot.

16. The UE of claim 11, wherein the reference CORESET includes a CORESET corresponding to a common search space (CSS) with an earliest starting time.

17. The UE of claim 11, wherein the reference CORESET includes a CORESET with a smallest or longest duration of selected from multiple such CORESETs corresponding to a common search space (CSS) with a same earliest starting time.

18. The UE of claim 11, wherein the reference CORESET corresponds to:
a common search space (CSS) with a lowest index in a cell with a lowest cell index containing CSS, if any; and
otherwise, corresponds to a UE search space (USS) with a lowest index in the cell with the lowest cell index.

19. The UE of claim 11, wherein the instructions, when executed by the processor, perform operations further comprising, in overlapping physical downlink control channel (PDCCH) monitoring occasions in multiple CORESETs in a single cell or among component carriers with same numerologies, identifying the CORESETs in the slot as the set.

20. The UE of claim 11, wherein the instructions, when executed by the processor, perform operations further comprising:
in overlapping physical downlink control channel (PDCCH) monitoring occasions in multiple CORESETs among component carriers (CCs) with different numerologies, setting a time unit according to a slot of a CC among the CCs with a smallest subcarrier spacing (SCS); and
identifying CORESETs in the time unit as the set.
